(19) United States
(12) Patent Application Publication
(10) Pub. No.: US 2003/0196677 A1
(43) Pub. Date: Oct. 23, 2003

(54) Illuminated dental floss holder

(76) Inventor: Michael Wiseman, Cote St-Luc (CA)

Correspondence Address: Stephan P. Georgiev, SMART & BIGGAR, Suite 3400, 1000 de la Gauchetiere Street West, Montreal, QC, H3B 4W5, CA

(21) Appl. No.: 10/357,436

(22) Filed: Feb. 4, 2003

Related U.S. Application Data
(60) Provisional application No. 60/353,232, filed on Feb. 4, 2002.

(51) Int. Cl. A61C 15/00

(52) U.S. Cl. 132/323

(57) ABSTRACT

A dental floss holder including a pair of arms capable of holding dental floss material therebetween, an illumination device and a switch. The illumination device is capable to acquire either one of an active mode and an inactive mode, in the active mode the illumination device generating light for emission from the dental floss holder. The switch selectively causes the illumination device to switch between the active mode and the inactive mode.

### CROSS-REFERENCE TO RELATED APPLICATION

The above-referenced application is based on U.S. provisional patent application No. 60/353,232, filed on Feb. 4, 2002.

### FIELD OF THE INVENTION

The present invention generally relates to the field of dental floss holders. More particularly, the present invention relates to a novel dental floss holder that is capable of, among other things, emitting light for illuminating the mouth cavity during flossing of teeth.

### BACKGROUND OF THE INVENTION

Dental floss holders are well known in the art, typically formed of a body having a linear portion for grasping the holder and a generally U-shaped or V-shaped end portion defined by a pair of arms or tines which hold a string of dental floss material therebetween. The dental floss is securely fixed to the arms at opposite ends thereof by any well-known manner. This construction of the dental floss holder enables the user to hold the linear portion while manipulating the dental floss between the user's teeth.

While the dental floss holder described above is suitable for its intended use, it does not provide for certain difficulties faced by the user during flossing. Firstly, during flossing of teeth, the user must manipulate the dental floss holder within the mouth cavity, where low-light conditions and shadows make it difficult to clearly see the spaces between the teeth, especially towards the back of the mouth cavity. Thus, matter caught between the teeth may be overlooked or missed by the user during flossing.

Secondly, the user of the dental floss holder will regularly wish to replace the used portion of dental floss string held between the arms of the dental floss holder with a new, unused portion, perhaps during a single flossing operation or between separate flossing operations. Unfortunately, in order to replace the used portion of dental floss fixed to the arms of the dental floss holder, the user must remove the string of dental floss from the dental floss holder and re-mount it to the dental floss holder such that an unused portion is located between the arms. Alternatively, the user may replace the entire string of dental floss with a new string of dental floss, which must obviously be mounted to the dental floss holder in order to proceed with the flossing operation. Such manipulations by the user are time consuming and quite inefficient.

The background information provided above clearly indicates that there exists a need in the industry to provide an improved dental floss holder for overcoming one or more of the limitations set forth above.

### SUMMARY OF THE INVENTION

The present invention provides in one aspect a dental floss holder including a pair of arms capable of holding dental floss material therebetween, an illumination device and a switch. The illumination device is capable to acquire either one of an active mode and an inactive mode, in the active mode the illumination device generating light for emission from the dental floss holder. The switch selectively causes the illumination device to switch between the active mode and the inactive mode.

In another aspect, there is provided a dental floss holder including a pair of arms defining a space therebetween, a dental floss guide path for receiving dental floss material, a dental floss dispenser and an illumination device. The dental floss dispenser includes an electrically powered drive unit for advancing dental floss material along the dental floss guide path, where the space between the arms defines a portion of the dental floss guide path. The illumination device includes an electrically powered light source for emitting light from the dental floss holder. The dental floss holder also includes a receptacle for holding a battery including battery terminals, where both the dental floss dispenser and the illumination device are electrically connected to the battery terminals.

The present invention advances the art of dental floss holders, and the techniques for creating same, beyond those previously known.

It is therefore a purpose of the present invention to provide a dental floss holder that emits light for lighting the mouth cavity during flossing, in order to facilitate and increase the effectiveness of flossing.

A further purpose of the present invention is to provide a dental floss holder capable to automatically displace the dental floss string mounted on the dental floss holder for positioning an unused portion of the dental floss string between the arms of the dental floss holder, in order to render flossing more time efficient.

### BRIEF DESCRIPTION OF THE DRAWINGS

The foregoing summary, as well as the following detailed description of the present invention, will be better understood when read in conjunction with the accompanying drawings. It is to be understood, however, that the drawings are provided for purposes of illustration only and not as a definition of the boundaries of the invention, for which reference should be made to the appending claims.

In the drawings:

FIG. 1A is a front elevational view of a dental floss holder, according to a first example of implementation of the present invention;

FIG. 1B is a cross-sectional view of the dental floss holder shown in FIG. 1A, taken along line I-I;

FIG. 2 is a cross-sectional view of the dental floss holder shown in FIG. 1A, taken along a vertical plane;

FIG. 3 illustrates an example of an electrical circuit for the dental floss holder shown in FIG. 1;

FIG. 4 is a cross-sectional view of a variant of the dental floss holder shown in FIG. 1A, taken along a vertical plane;

FIG. 5 is a cross-sectional view of a dental floss holder taken along a vertical plane, according to a second example of implementation of the present invention;

FIG. 6 is a cross-sectional view of a variant of the dental floss holder shown in FIG. 5, taken along a vertical plane;

FIG. 7 is a front elevational view of a dental floss holder, according to a third example of implementation of the present invention;

FIG. 8 illustrates an example of an electrical circuit for the dental floss holder shown in FIG. 7; and

FIG. 9 illustrates a side elevational view of a dental floss holder, according to a fourth example of implementation of the present invention.

### DETAILED DESCRIPTION

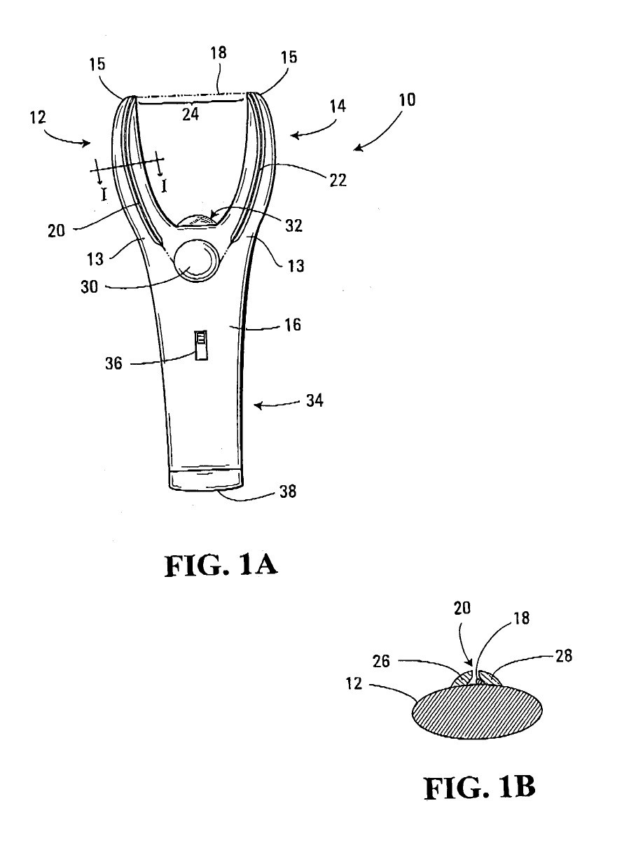

Referring now to the drawings, wherein similar reference characters designate corresponding parts throughout the several views, a first example of implementation of a dental floss holder according to the present invention is generally illustrated at 10 in FIGS. 1A, 1B, 2 and 3. The dental floss holder 10 includes a pair of arms, generally indicated at 12, 14, which extend from body 16.

Preferably, the arms 12, 14 are fabricated from any suitable polymeric material, such as medical grade polypropylene for use in Class 1 FDA medical devices.

The body 16 of the dental floss holder 10 defines a handle portion generally indicated at 34. This handle portion 34 allows for the dental floss holder 10 to be held and manually manipulated by a user during flossing.

Each one of arms 12, 14 has a proximal end 13 adjacent to the handle portion 34 and a distal end 15 that is remote from handle portion 34.

A dental floss guide path is provided for receiving dental floss 18. This dental floss guide path is defined by receiving channel 20 of arm 12, receiving channel 22 of arm 14 as well as the space between distal ends of arms 12 and 14 generally indicated at 24.

FIG. 1B illustrates a cross-sectional view of the arm 12 of dental floss holder 10, taken along line I-I of FIG. 1A. As shown, the receiving channel 20 includes a pair of walls 26, 28 mounted in close proximity on the arm 12 and defining a gap therebetween for receiving and guiding the dental floss 18.

The receiving channel 22 of arm 14 is substantially identical to the receiving channel 20 of arm 12, and as such will not be described in further detail.

Dental floss 18 is received in the dental floss guide path such that it spans between the two arms 12, 14 in the manner illustrated in the drawings. The dental floss 18 can also be fabricated from any suitable material, such as nylon or polytetrafluoroethylene (“PTFE”), for example.

A holding member 30 is provided on the body 16. This holding member 30 allows for dental floss 18 to be mounted onto the dental floss holder 10 and received in the dental floss guide path. Typically, once a portion of a string of dental floss 18 has been received in the dental floss guide path, the ends of the dental floss string 18 are wrapped around the holding member 30. This secures the string 18 to the dental floss holder 10, and ensures that the portion of the string 18 received in the dental floss guide path has, and maintains, a requisite amount of tension during flossing. Such a holding member 30 is well known in the art and as such will not be described in any further detail.

Specific to the present invention, the dental floss holder 10 also includes an electrically powered illumination device generally indicated at 32. In the active mode, this illumination device 32 generates light for emission from the dental floss holder 10, as will be described in further detail below. In the inactive mode, electrical power to the illumination device 32 is cut off, such that no light is emitted from the illumination device 32.

A switch 36 is provided on the handle portion 34 of the dental floss holder 10 for controlling the illumination device 32. More specifically, the switch 36 is connected to the electrical circuit of the illumination device 32, as will be discussed below. Thus, during flossing, the switch 36 can be manipulated by a user for selectively switching the illumination device 32 from the active mode to the inactive mode, and vice versa. Such a switch 36 is well known in the art and as such will not be described in any further detail.

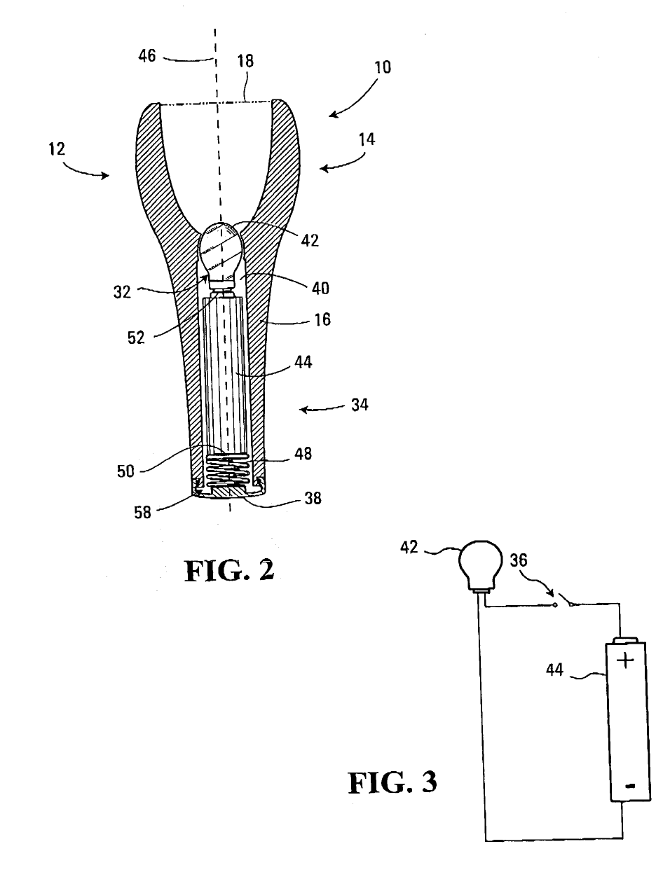

As shown in FIG. 2, the body 16 of the dental floss holder 10 includes a hollow, substantially cylindrical passage 40, which acts as a receptacle for receiving the illumination device 32. This passage 40 extends throughout the handle portion 34, from opening 54 located at the junction of arms 12, 14 to opening 58.

Opening 58 is sealed by cap 38, which is removably attached to the handle portion 34.

The illumination device 32 includes a light source 42 and a power source 44. In this specific example, the light source 42 is a light bulb and the power source 44 is a battery. As shown, the light bulb 42 projects partly from opening 54, into the U-shaped space defined between arms 12, 14.

Note that opening 54 is sized such as to allow a portion of the light bulb 42 to project from the body 16 of the dental floss holder 10, all the while ensuring that the light bulb 42 remains within the passage 40 of the body 16.

The cap 38 is threadedly engaged on the handle portion 34, which defines a longitudinal axis 46. Rotation of the cap 33 about the longitudinal axis 46 tightens the cap 38 onto the handle portion 34. A grounded spring 48 is positioned between the cap 38 and the battery terminal 50, for securing the illumination device 32 within the passage 40 and for exerting sufficient pressure on the battery 44 in order to maintain contact between the battery 44 and the light bulb 42 at battery terminal 52.

In this example of implementation, the light bulb 42 and battery 44 are replaceable, since disengagement of the cap 38 permits for removal of the light bulb 42 and battery 44 from the passage 40 via opening 58 of handle portion 34. Alternatively, the dental floss holder 10 could be made to be disposable, in which case cap 38 would either be permanently connected to the handle portion 34 or would be replaced with a permanent seal.

FIG. 3 illustrates an example of an electrical circuit for the illumination device 32. When switch 36 is closed, the illumination device 32 acquires the active mode. In the active mode, current flows from battery 44 to light bulb 42 such that the battery 44 supplies power for operation to the light bulb 42 and the latter emits light. When switch 36 is open, the illumination device 32 acquires the inactive mode, in which the electrical connection between the battery 44 and the light bulb 42 is broken, such that the light bulb 42 does not emit any light.

In operation, dental floss 18 is mounted onto the dental floss holder 10, and received in the dental floss guide path, such that the dental floss holder 10 is ready for flossing. During flossing, a user can activate the illumination device 32 by operating switch 36, such that the light bulb 42 emits light for illuminating the mouth cavity. Assuming that the user is flossing while looking into a mirror, once the light bulb 42 is turned on, the user can more easily see where to position the dental floss within the mouth cavity, which facilitates flossing. The user can de-activate the illumination device 32 by once again operating switch 36, thus turning off the light bulb 42.

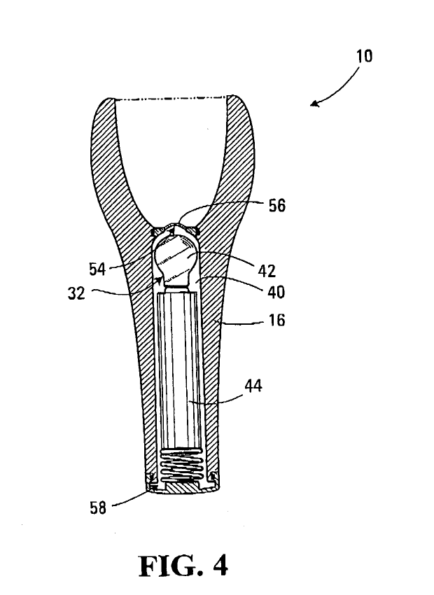

In a variant of this example of implementation, the illumination device 32 is completely contained within the passage 40 of the body 16, as shown in FIG. 4. The light bulb 42 is located adjacent the opening 54, such that when the illumination device 32 is in the active mode, light generated by the light bulb 42 is emitted from the dental floss holder 10 via opening 54. In this variant, the opening 54 is sized such that no portion of the light bulb 42 can project from the opening 54. A transparent, protective cover 56 is mounted to the body 16 of the dental floss holder 10, in order to shield the opening 54 while still permitting light generated by the light bulb 42 to be emitted from the opening 54.

In the example of FIG. 4, the protective cover 56 is threadedly engaged to the body 16, such that the protective cover 56 is removable. Alternatively, the protective cover 56 may be permanently attached to the body 16, for example with glue or some other form of adhesive.

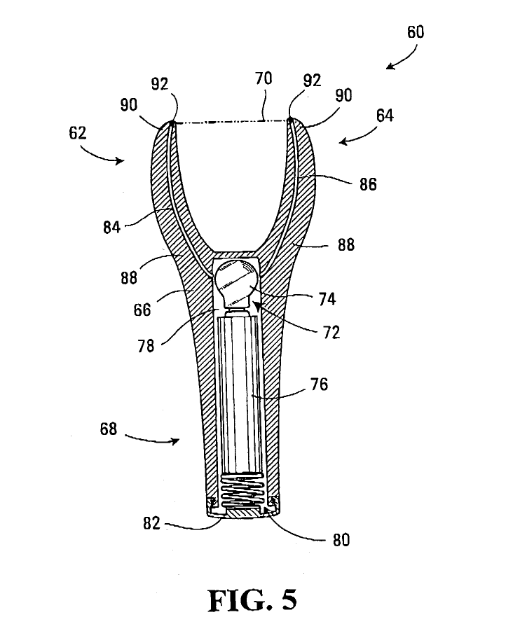

FIG. 5 illustrates a second example of implementation of a dental floss holder, according to the present invention. In this second example of implementation, dental floss holder 60 includes a pair of arms, generally indicated at 62, 64, which extend from body 66. A handle portion generally indicated at 68 allows for the dental floss holder 60 to be held and manually manipulated by a user during flossing. Although not shown, a dental floss guide path is provided for receiving dental floss 70, as described above in the first example of implementation.

The dental floss holder 60 also includes an electrically powered illumination device generally indicated at 72, having the same functionality as the illumination device described above in the first example of implementation. Although not shown, a switch is provided on the handle portion 68 for selectively switching the illumination device 72 from the active mode to the inactive mode, and vice versa.

The body 66 of the dental floss holder 60 includes a substantially cylindrical cavity 78, which acts as a receptacle for receiving the illumination device 72. The cavity 78 has an open end at 80, which is sealed by a cap 82 that is removably attached to the handle portion 68.

As shown in FIG. 5, the illumination device 72 includes a light source 74 and a power source 76. In this specific example, the light source 74 is a light bulb and the power source 76 is a battery. Both the light bulb 74 and the power source 76 are contained within the cavity 78.

Note that the same electrical circuit as described above in the first example of implementation connects the light bulb 74 and the battery 76, and as such will not be discussed in further detail.

Specific to this example of implementation of the present invention, the illumination device 72 also includes a pair of optical fibers 84, 86 mounted in arms 62, 64, respectively. Each optical fiber extends between the proximal end 88 and the distal end 90 of the respective arm. More specifically, one end of each optical fiber 84, 86 is located adjacent to the light bulb 74, while the other end of each optical fiber 84, 86 includes a light delivery tip 92 located adjacent to the distal end 90 of the respective arm. Thus, when the illumination device 72 is in the active mode, light generated by the light bulb 74 is collected by optical fibers 84, 86 and emitted from the dental floss holder 60 via light delivery tips 92.

In the example shown in FIG. 5, the light delivery tips 92 of optical fibers 84, 86 project slightly from the distal ends 90 of the arms 62, 64, such that light generated within the body 66 of dental floss holder 60 can be emitted externally from the dental floss holder 60.

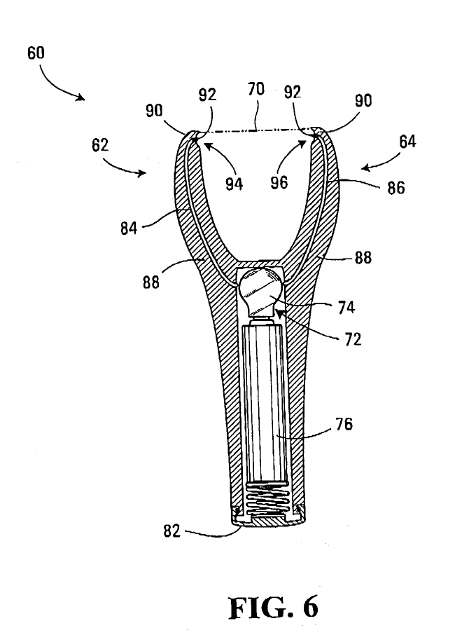

In a variant of this second example of implementation shown in FIG. 6, the light delivery tips 92 of optical fibers 84, 86 project from the arms 62, 64 at positions 94, 96 located along arms 62, 64, respectively. Thus, light generated by the light bulb 74 is emitted by the delivery tips 92 into the U-shaped space between the arms 62, 64 Note that position 94 may be located anywhere intermediate the proximal and distal ends 88, 90 of the arm 62, while position 96 may be located anywhere intermediate the proximal and distal ends 88, 90 of the arm 64.

Note that in another variant, the illumination device 72 of dental floss holder 60 includes only a single optical fiber, mounted in either one of arms 62, 64.

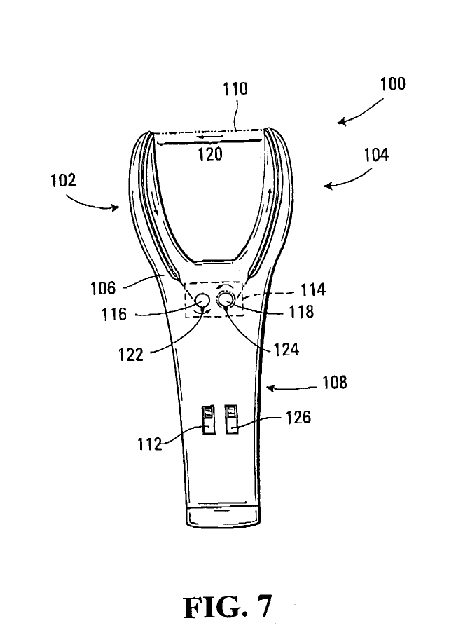

FIG. 7 illustrates a third example of implementation of a dental floss holder, according to the present invention. In this third example of implementation, dental floss holder 100 includes a pair of arms, generally indicated at 102, 104, which extend from body 106. A handle portion generally indicated at 108 allows for the dental floss holder 100 to be held and manually manipulated by a user during flossing. A dental floss guide path is provided for receiving dental floss 110, as described above in the first example of implementation.

Although not shown, the dental floss holder 100 also includes an electrically powered illumination device, having the same functionality as the illumination device described above in the first example of implementation. A switch 112 is provided on the handle portion 108 for selectively switching the illumination device from the active mode to the inactive mode, and vice versa, as described above with regard to the first example of implementation.

Although not shown, the structure of the illumination device for the dental floss holder shown in FIG. 7 is the same as that described above in the second example of implementation. Thus, the illumination device includes a light source and a power source mounted within the body 106, as well as one or more optical fibers mounted in the arms 102, 104.

Specific to this example of implementation of the present invention, the dental floss holder 100 includes a dental floss dispenser 114 for advancing dental floss 110 mounted to the dental floss holder 100 along the dental floss guide path. The dental floss dispenser 114 includes a drive unit that is electrically powered by the power source of the illumination device, as will be described in further detail below,

Dental floss dispenser 114 includes a pair of rotatable holding members 116, 118 mounted to the body 106. Holding members 116, 118 perform a dual function on the dental floss holder 100. On the one hand, they allow for a string of dental floss 110 to be mounted onto the dental floss holder 100 and received in the dental floss guide path. On the other hand, they are operative to displace the string of dental floss 110 along the dental floss guide path, such that when the portion of dental floss 110 held between arms 102, 104 (spanning the space generally indicated at 120) is used, it can be automatically replaced with a new, unused portion of the dental floss 110.

Each one of the holding members 116, 118 includes a resiliently-biased clasp 122, 124, respectively, for securing an end of the string of dental floss 110 to the respective holding member, such that rotation of the holding members 116, 113 causes displacement of the dental floss 110 along the dental floss guide path.

During mounting of a string of dental floss 110 to the dental floss holder 100, a pressure is manually exerted on clasp 122 in order to move the clasp 122 away from the holding member 116. One end of the string is then inserted into the gap formed between the clasp 122 and the holding member 116, and the clasp 122 released such that it returns to its original, biased position and clamps the string to the holding member 116. The string is then mounted along the dental floss guide path, the remaining portion of the string being wrapped around the holding member 118.

Preferably, the length of the string of dental floss 110 is at least double the length of the dental floss guide path.

Finally, a pressure is manually exerted on clasp 124 in order to move the clasp 124 away from the holding member 118. The second end of the string is then inserted into the gap formed between the clasp 124 and the holding member 118, and the clasp 124 released such that it returns to its original, biased position and clamps the string to the holding member 118.

Note that the string of dental floss 110 is mounted to the dental floss holder 100 such that the string has a requisite amount of tension for flossing purposes.

The dental floss dispenser 114 also includes a drive unit (not shown in FIG. 7) that is mounted in the body 106 of the dental floss holder 100 along with the illumination device. In this example of implementation, the drive unit is a motor. The motor is coupled to the holding member 116 for rotating the holding member 116 in the counter-clockwise direction, such that the used portions of the string of dental floss 110 are wound onto the holding member 116 and fresh, unused portions of the string are unwound from the holding member 118.

The holding member 118 is mechanically rotatable but not motorized. As a result of the winding of the string of dental floss 110 onto the holding member 116, the holding member 118 is forced to rotate in the counter-clockwise direction, thus releasing the dental floss 110 wound around the holding member 118.

Clasps 122 and 124 ensure that the string of dental floss 110 is displaced, and not dislodged, during motorized rotation of the holding member 116 and mechanical rotation of the holding member 118.

A second switch 126 is provided on the handle portion 108 for controlling the dental floss dispenser 114. More specifically, the switch 126 is connected to the electrical circuit of the dental floss dispenser 114, as will be discussed below. Thus, during flossing, the switch 126 can be manipulated by a user for selectively activating or de-activating the dental floss dispenser 114, in order to cause or suspend displacement of the dental floss 110 along the dental floss guide path.

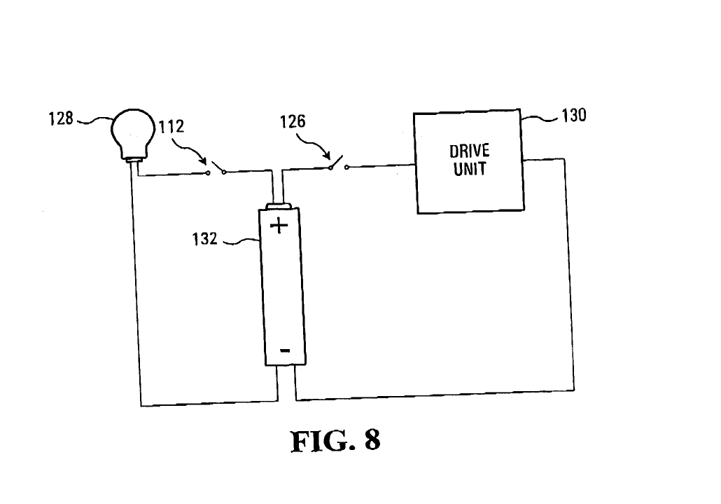

FIG. 8 illustrates an example of an electrical circuit for the dental floss holder 100. Battery 132 powers both the light bulb 128 of the illumination device and the motor 130 of the dental floss dispenser 114. When switch 112 is closed, the illumination device acquires the active mode, current flowing from battery 132 to light bulb 128 such that latter emits light. When switch 112 is open, the illumination device acquires the inactive mode, in which the electrical connection between the battery 132 and the light bulb 128 is broken, such that the light bulb 128 does not emit any light

When switch 126 is closed, current flows from battery 132 to the motor 130, such that the motor 130 is energized and operates to rotate holding member 116, thus displacing the dental floss 110 along the dental floss guide path. When switch 126 is open, the electrical connection between the battery 132 and the motor 130 is broken, such that rotation of the holding member 116, and thus displacement of the dental floss 110, is suspended.

In operation, the dental floss holder 100 is capable to emit light as well as automatically displace dental floss 110 along the dental floss guide path, through manipulation of switches 112 and 126 by the user during flossing.

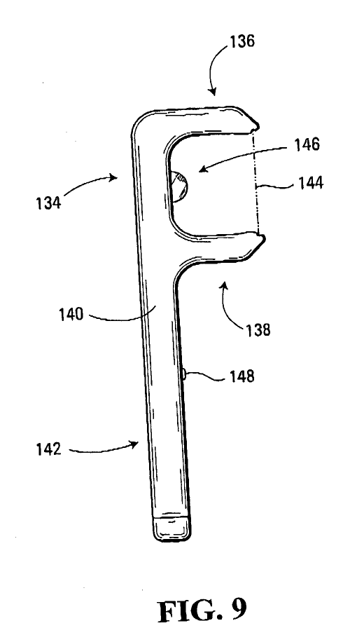

FIG. 9 illustrates a fourth example of implementation of a dental floss holder, according to the present invention. In this fourth example of implementation, dental floss holder 134 includes a pair of arms, generally indicated at 136, 138, which extend from body 140. A handle portion generally indicated at 142 allows for the dental floss holder 134 to be held and manually manipulated by a user during flossing. Dental floss 144 is securely fixed to, and held between, the arms 136 and 138 at opposite end thereof.

The dental floss holder 134 also includes an electrically powered illumination device generally indicated at 146, having the same functionality as the illumination device 32 described above in the first example of implementation. A switch 148 is provided on the handle portion 142 for selectively switching the illumination device 146 from the active mode to the inactive mode, and vice versa, as described above with regard to the first example of implementation.

Although not shown, the structure of the illumination device 146 for the dental floss holder shown in FIG. 9 is the same as that described above in the first example of implementation. Thus, the illumination device 146 includes a light source, such as a light bulb, and a power source, such as a battery, mounted within the body 140.

Alternatively, the structure of the illumination device 146 for the dental floss holder shown in FIG. 9 may be the same as that described above in the second example of implementation. In this case, the illumination device 146 would include a light source and a power source mounted within the body 140, as well as one or more optical fibers mounted in the arms 136, 138.

Specific to the example of implementation shown in FIG. 9, the dental floss holder 134 is characterized by a generally C-shaped end portion, which is defined by the pair of arms 136, 138. For certain users, this C-shaped construction of the dental floss holder 134 may facilitate the manipulation of the dental floss 144 between the user's teeth.

It should be noted that various shapes and sizes of the dental floss holder 134, more specifically of the handle portion 142 as well as of the end portion formed by the pair of arms 136, 138, are possible without departing from the scope of the present invention.

The above detailed description should not be interpreted in any limiting manner as refinements and variations can be made without departing from the spirit of the invention. The scope of the invention is defined in the appended claims and their equivalents.

I claim:

1. A dental floss holder comprising:
a body;
a pair of arms extending from said body, said pair of arms capable of holding dental floss material therebetween;
an illumination device capable to acquire either one of an active mode and an inactive mode, in said active mode said illumination device generating light for emission from said dental floss holder;
a switch for selectively causing said illumination device to switch between said active mode and said inactive mode.

2. A dental floss holder as defined in claim 1, wherein said illumination device includes a light source and a power source mounted in said body.

3. A dental floss holder as defined in claim 2, wherein said body defines a handle portion, each one of said pair of arms including a proximal end adjacent said handle portion and a distal end remote from said handle portion.

4. A dental floss holder as defined in claim 3, wherein the proximal ends of said pair of arms define a junction, said body including an opening at the junction of said pair of arms, said light source being mounted adjacent said opening, whereby light generated by the light source is emitted from said dental floss holder via said opening.

5. A dental floss holder as defined in claim 4, wherein said pair of arms define a space therebetween, the light source projecting at least in part from said opening into the space between said pair of arms.

6. A dental floss holder as defined in claim 4, wherein said dental floss holder further includes a light transmissive protective cover removably mounted to said body for shielding said opening.

7. A dental floss holder as defined in claim 2, wherein the light source is a light bulb and the power source is a battery.

8. A dental floss holder as defined in claim 3, wherein said illumination device further includes at least one optical fiber.

9. A dental floss holder as defined in claim 8, wherein the optical fiber is mounted along one of said pair of arms.

10. A dental floss holder as defined in claim 9, wherein said illumination device includes a pair of optical fibers, each optical fiber being mounted in a respective one of said pair of arms.

11. A dental floss holder as defined in claim 10, wherein each optical fiber includes a light delivery tip located adjacent to the distal end of said respective arm.

12. A dental floss holder as defined in claim 10, wherein each optical fiber includes a light delivery tip located between the proximal and distal ends of said respective arm.

13. A dental floss holder comprising:
a body;
a pair of arms extending from said body, said pair of arms define a space therebetween;
a dental floss guide path for receiving dental floss material, the space between said arms defining a portion of said dental floss guide path;
a dental floss dispenser including an electrically powered drive unit for advancing dental floss material along said dental floss guide path;
an illumination device including an electrically powered light source mounted to said dental floss holder;
a receptacle for holding a battery including battery terminals, both said dental floss dispenser and said illumination device being electrically connected to said battery terminals.
